(19) United States
(12) Patent Application Publication
(10) Pub. No.: US 2021/0232813 A1
(43) Pub. Date: Jul. 29, 2021

(54) PERSON RE-IDENTIFICATION METHOD COMBINING REVERSE ATTENTION AND MULTI-SCALE DEEP SUPERVISION

(71) Applicant: TONGJI UNIVERSITY, Shanghai (CN)

(72) Inventors: Deshuang HUANG, Shanghai (CN); Di WU, Shanghai (CN)

(21) Appl. No.: 17/027,241

(22) Filed: Sep. 21, 2020

(30) Foreign Application Priority Data
Jan. 23, 2020 (CN) 202010076654.8

(51) Int. Cl. G06K 9/00; G06K 9/62; G06N 3/08

(52) U.S. Cl. CPC G06K 9/00369; G06K 9/6262; G06N 3/082; G06K 9/6257

(57) ABSTRACT

The present invention relates to a person re-identification method combining reverse attention and multi-scale deep supervision, including: constructing a person re-identification training network; training the person re-identification training network by using a training data set, to obtain a learning network, and discarding a reverse attention branch and a multi-scale deep supervision branch of a feature extraction module in the learning network, to obtain a test network; testing the test network by using a test data set, and after the test succeeds, inputting an actual data set into the learning network, to learn an image feature of the actual data set, and then discarding the reverse attention branch and the multi-scale deep supervision branch of the feature extraction module in the learning network, to obtain an application network; and inputting an actual query image into the application network, to obtain an identification result corresponding to the actual query image.

### TECHNICAL FIELD

The present invention relates to the field of identified image processing technologies in a computer model, and in particular, to a person re-identification method combining reverse attention and multi-scale deep supervision.

### BACKGROUND ART

Person re-identification (PReID) refers to the re-identification of a specific person of interest through different cameras or a single camera at different time points in a camera network. This technology has been extensively studied in recent years. Because of the application of person re-identification in intelligent video surveillance and security systems, the development of deep learning systems, established large-scale PReID data sets, and the like are of great significance and have attracted widespread attention from a computer vision community. However, this task is still very difficult due to large changes in clothing, postures, lighting, uncontrolled complex backgrounds, and the like of persons captured. In recent years, a large number of studies have made the performance of the PReID enhanced. The work can be classified into two classes: One is to use the deep networks to learn discriminative features to represent persons. Early deep networks include VGGNet and DensNet. Recently, some attention-based deep models have been proposed, such as SENet, CBAM, and SKNet.

These models introduce an attention module into the most advanced deep architecture to learn a relationship between spatial information and a channel. Generally speaking, a softmax score generated by the attention module multiplied by an original feature is used as a final emphasized feature. As a part of the overall features of a body, these unemphasized features are also very important to enhance a description feature identification capability, especially when a description feature includes body information, thus, the unemphasized features should be regarded as the emphasized features to help learn the final features. However, these existing attention-based deep PREID models rarely consider this issue.

To this end, an idea of using a middle-level feature of a deep framework is studied, and a deep model is proposed, which combines embedding of a plurality of convolutional network layers and trains the convolutional network layers through deep supervision. The experimental results show the effectiveness of this strategy. However, the convolutional network layers combine low-level and high-level embeddings for training and testing, thereby reducing efficiency of the inference network framework.

In addition, multi-scale feature learning helps to enhance feature stability. Some studies have proposed a deep pyramid feature learning framework, which includes multi-angle specific branches of multi-scale deep feature learning. Complementarity of multi-angle features is learned and combined by using angle combination branches, and each tick in a pyramid may be specifically learned in each branch, which is of great benefit to improvement of the performance of the PReID. However, using a plurality of branches to obtain multi-scale information may increase the complexity of the network framework.

Reviewing study results of PReID, the following strategies can be introduced to enhance the performance of the deep model: (1) an attention mechanism; (2) a middle-level feature for deep supervision; (3) multi-scale feature learning. Nevertheless, using attention mechanisms may cause the loss of important feature information. In addition, introducing the middle-level features to the final descriptors for deep supervision and adding the multi-scale features learning lower the efficiency of the model.

### SUMMARY

To overcome the disadvantages existing in the prior art, an objective of the present invention is to provide a person re-identification method combining reverse attention and multi-scale deep supervision.

The objective of the present invention may be implemented by using the following technical solutions: a person re-identification method combining reverse attention and multi-scale deep supervision, including the following steps:

S1. constructing a person re-identification training network including a feature extraction module and an identification output module, where a basic network of the feature extraction module uses a convolutional neural network ResNet50, and includes a global branch, a reverse attention branch, and a multi-scale deep supervision branch;

S2. obtaining a training data set and a test data set;

S3. training the person re-identification training network by using the training data set, to obtain a person re-identification learning network; and shielding a reverse attention branch and a multi-scale deep supervision branch of a feature extraction module in the person re-identification learning network, to obtain a person re-identification test network;

S4. testing the person re-identification test network by using the test data set, and after the test succeeds, performing step S5; otherwise, returning to step S3;

S5. obtaining an actual data set and an actual query image;

S6. inputting the actual data set into the person re-identification learning network, to learn an image feature of the actual data set; then shielding the reverse attention branch and the multi-scale deep supervision branch of the feature extraction module in the person re-identification learning network, to obtain a person re-identification application network; and

S7. inputting the actual query image into the person re-identification application network, to obtain an identification result corresponding to the actual query image.

Further, the global branch in step S1 is used to extract global information of an image, including an attention module unit, an average pooling layer, and batch normalization that are sequentially connected, the attention module unit is divided into a first stage, a second stage, a third stage, and a fourth stage that are used for extracting a feature map, the attention module unit and the average pooling layer are combined to form a first global branch, and the attention module unit, the average pooling layer, and the batch normalization are combined to form a second global branch;

the reverse attention branch is used to extract, from feature maps extracted from the first stage to the fourth stage, feature information ignored by the attention module unit; and

the multi-scale deep supervision branch is used to extract feature information in horizontal and vertical directions from the feature maps extracted from the second stage and the third stage.

Further, the first global branch uses a ranked triplet loss function, and the second global branch uses an identity loss function; and

both the reverse attention branch and the multi-scale deep supervision branch use an identity loss function.

Further, the reverse attention branch includes a reverse attention module unit and an average pooling layer that are sequentially connected, and input of the reverse attention module unit is separately output from the first stage to the fourth stage.

Further, the attention module unit includes a channel attention module and a spatial attention module, and the channel attention module includes one average pooling layer and two linear layers, to generate weight values corresponding to different channels; and

the spatial attention module includes two dimension reduction layers and two convolutional layers, to emphasize features at different spatial positions.

Further, specific calculation formulas of the attention module unit are listed as follows:

ATT=σ(ATT_{C}×ATT_{S});

ATT_{C}=BN(linear1(linear2(M_{C})));

ATT_{S}=BN(Reduction2(Conv2(Conv1(M_{C}))));

M_{C}=Avgpool(M);

Mϵ [symbol] ^{C*W*H},M_{C}ϵ [symbol] ^{C*1*1},

where ATT is an attention module, ATT_{C} indicates channel attention that is output, ATT_{S} indicates spatial attention that is output, linear1 is a first linear layer, linear2 is a second linear layer, BN the batch normalization, Conv2 and Conv1 respectively indicate two convolutional layers, Reduction2 indicates a second dimension reduction layer, AvgPool indicates an average pooling operation, M is a feature map, M_{C} is a feature map on which average pooling is performed, [symbol] ^{C*W*H} is a dimension of a feature map that is input, and [symbol] ^{C*1*1} is a dimension of a feature map obtained after average pooling operation is performed.

Further, a specific calculation formula of the reverse attention module unit is as follows:

ATT_{R}=1−σ(ATT_{C}×ATT_{S}),

where ATT_{R} is a reverse attention module.

Further, the multi-scale deep supervision branch includes four one-dimensional convolution kernels, and the kernel sizes of the four one-dimensional convolutions are set to 1×3, 3×1, 1×5, and 5×1, respectively.

Further, the identity loss function is specified as follows:

$${L}_{ID} = {\sum }_{i = 1}^{N} - {q}_{i} log ( {p}_{i} ) ;$$

$${q}_{i} = \{ \begin{matrix}1 - \frac{( N - 1 ) ɛ}{N} & if i = y \\ \frac{ɛ}{N} & otherwise\end{matrix} ; \\ ɛ = 0.1 ,$$

where L_{ID} is an identity loss, pᵢ is a prediction approximation, qᵢ is a smooth identity weight, y is a true identity of a sample, i is an identity predicted by a network, N represents a number of training samples, and ε is a constant.

Compared with the prior art, the present invention has the following advantages:

1. In the present invention, some of the middle-level features of a network are extracted and added to the reverse attention module unit, which can make an the unemphasized features become an the emphasized features, thereby effectively resolving the a problem of information loss that is likely to occur when only the attention module unit is used to extract features.

2. In the present invention, multi-angle feature information is respectively extracted from horizontal and vertical directions by setting multi-scale deep supervision branches in the network and by using a plurality of lightweight convolution kernels on a one-dimensional scale. In this way, it is ensured that in addition to the extraction of the multi-angle feature information, a number of parameters can be greatly reduced, storage capacity requirements can be reduced, and a network framework structure can be simplified.

3. In the present invention, the reverse attention module branch and multi-scale deep supervision branch are used to extract features only during network training and network learning, and the reverse attention module branch and the multi-scale deep supervision branch are discarded during network testing and network application. Only the global branch is reserved for person re-identification calculation, so as to accelerate an identification calculation speed and increase identification efficiency while ensuring identification accuracy.

### BRIEF DESCRIPTION OF THE DRAWINGS

FIG. 1 is a schematic flowchart of a method according to the present invention;

FIG. 2 is a schematic diagram of an overall structure of a training network or a learning network according to the present invention;

FIG. 3 is a schematic structural diagram of a multi-scale deep supervision branch; and

FIG. 4 is a schematic diagram of an overall structure of a test network or an application network according to the present invention.

### DETAILED DESCRIPTION

The present invention is described in detail below with reference to the accompanying drawings and specific embodiments.

### Embodiment

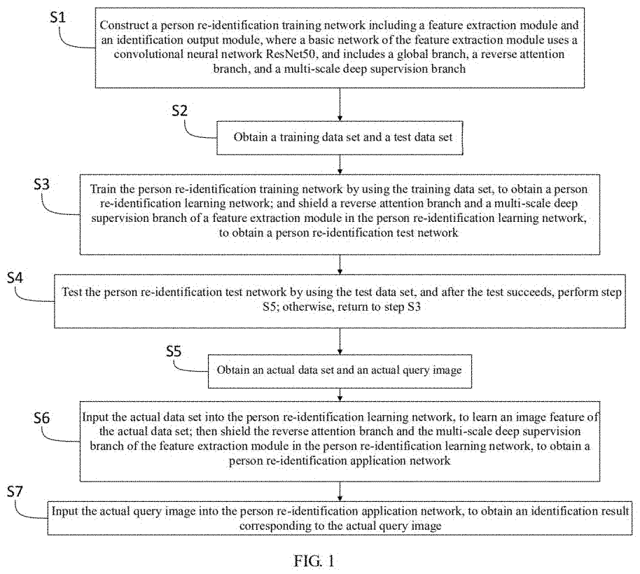

As shown in FIG. 1, a person re-identification method combining reverse attention and multi-scale deep supervision includes the following steps:

S1. Construct a person re-identification training network including a feature extraction module and an identification output module, where a basic network of the feature extraction module uses a convolutional neural network ResNet50, and includes a global branch, a reverse attention branch, and a multi-scale deep supervision branch.

S2. Obtain a training data set and a test data set.

S3. Train the person re-identification training network by using the training data set, to obtain a person re-identification learning network; and discard a reverse attention branch and a multi-scale deep supervision branch of a feature extraction module in the person re-identification learning network, to obtain a person re-identification test network.

S4. Test the person re-identification test network by using the test data set, and after the test succeeds, perform step S5; otherwise, return to step S3.

S5. Obtain an actual data set and an actual query image.

S6. Input the actual data set into the person re-identification learning network, to learn an image feature of the actual data set; then discard the reverse attention branch and the multi-scale deep supervision branch of the feature extraction module in the person re-identification learning network, to obtain a person re-identification application network.

S7. Input the actual query image into the person re-identification application network, to obtain an identification result corresponding to the actual query image.

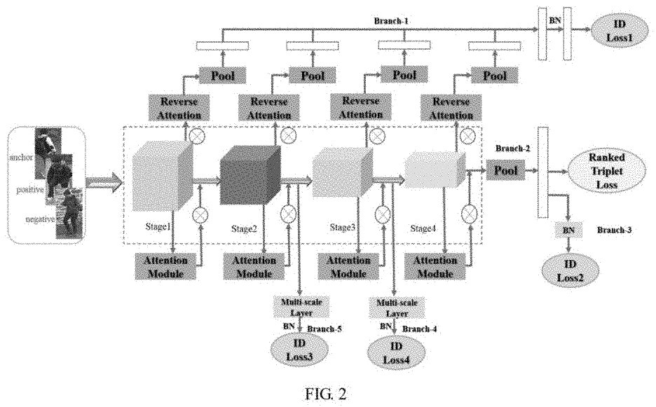

As shown in FIG. 2, in the present invention, ResNet50 is used as a basic network for feature extraction, and a reverse attention module is used to compensate for a loss of some important features caused by the attention module. In addition, a multi-scale deep supervision layer is further added to train a basic framework network. This framework includes 5 branches. A branch-1 includes a reverse attention module branch, to extract feature information ignored by an attention module. A branch-2 uses a triplet loss, a branch-3 uses a classification loss, and both the branch-2 and the branch-3 are used to extract global information. Deep supervision branches with multi-scale feature learning are a branch-4 and a branch-5. The entire feature extraction network framework uses 5 loss functions: four classification losses and one triplet loss.

Specifically, in the present invention, the feature extraction module is constructed by using a basic framework of the convolutional neural network ResNet50, an original spatial down-sampling operation layer, an original global average pooling operation layer, and an original fully connected layer are deleted, and an average pooling layer and a linear classification layer are added at a rear end of ResNet50. The attention module and the reverse attention module are constructed by using feature maps generated in a stage 1, a stage 2, a stage 3, and a stage 4 of ResNet50, and multi-scale deep supervision is constructed by using the feature maps generated in the stage 2 and the stage 3, to respectively constitute the branch-5 and the branch-4.

Reverse attention modules in the four stages together constitute a branch-1.

Attention modules in the four stages are combined, an average pooling layer is then added, and a ranked triplet loss is used to form the branch-2.

The attention modules in the four stages are combined, the average pooling layer is then added, batch normalization (BN) is then performed, and an identity (ID) loss 2 is used to form the branch-3.

Therefore, the five branches are formed, and four identity losses (ID Loss) and one ranked triplet loss in total are used to measure a distance scale of features.

The attention module includes a channel attention module and a spatial attention module, the channel attention module generates different weight values for channels, and the spatial attention module focuses on different information areas. The channel attention module includes one average pooling layer and two linear layers, and the average pooling layer may be expressed by using the following formula:

M_{C}=Avgpool(M).

Two linear layers and a batch normalization layer follow the average pooling layer, and are used to evaluate attention on each channel. The output of the first linear layer is set to C/r, and r represents a scaling rate. To maintain a number of channels, the output of a second linear layer is set to C. The batch normalization layer (BN) follows the two linear layers, and is used to adjust a scale of channel attention. The formula of the channel attention is as follows:

ATT_{C}=BN(linear1(ihnear2(M_{C}))); and

Mϵ [symbol] ^{C*W*H},M_{C}ϵ [symbol] ^{C*1*1}.

The spatial attention module is set to enhance the significance of a feature at different spatial positions. The spatial attention module includes two dimension reduction layers and two convolutional layers. A first dimension reduction layer reduces a feature Mϵ [symbol] ^{C*W*H} to M_{S}ϵ [symbol] ^{C/r*W*H}. Then M_{S} is reduced to [symbol] ^{1*W*H} by using a convolution kernel having a size of 3×3 and by using the two convolutional layers. Finally, the spatial attention module uses one batch normalization layer to adjust a scale of spatial attention. The formula of the spatial attention module is as follows:

ATT_{S}=BN(Reduction2(Conv2(Conv1(M_{C})))),

where Conv2 and Conv1 respectively indicate the two convolutional layers, Reduction2 indicates the second dimension reduction layer, and finally the channel attention module and the spatial attention module are combined, to obtain the following calculation formula of the attention module:

ATT=σ(ATT_{C}×ATT_{S}).

Further, a calculation formula of the reverse attention module is as follows:

ATT_{R}=1−σ(ATT_{C}×ATT_{S}).

Point multiplication is performed on features obtained at the stages and ATT_{R}, and then the features are pooled and concatenated together, to form the branch-1.

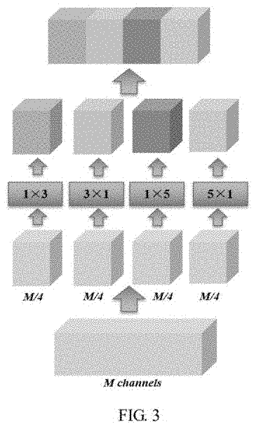

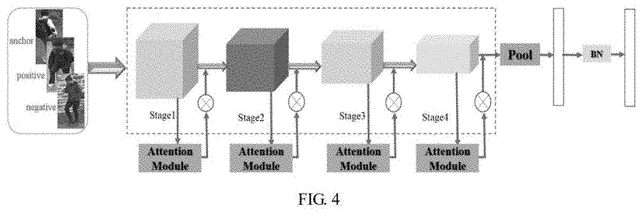

Both the branch-5 and the branch-4 include a multi-scale layer. As shown in FIG. 2, the multi-scale layer divides features output by the attention module into four parts that are convoluted through four convolution kernels (which are 1×3, 3×1, 1×5, 5×1 respectively), and obtained results are concatenated together. A structure of the multi-scale layer is shown in FIG. 3. A reason why the four convolution kernels use one-dimensional scale is as follows: one-dimensional convolution has less parameter and reduces GPU memory consumption. One-dimensional convolution operation can learn the pedestrian features from horizontal and vertical directions, respectively, which adapts to the human visual perception. During network training and learning, the branch-1 to the branch-5 all participate in network calculation to ensure overall accuracy of feature extraction. During network testing and application, a case is shown in FIG. 4. The branch-1, the branch-2, the branch-4, and the branch-5 are shielded, and only the branch-3 is reserved for network calculation, to improve identification calculation efficiency.

In this embodiment, the method proposed by the present invention is separately applied to Market-1501, DukeMTMC-reID, and CUHK03 data sets. An identification result of this method is compared with that of an existing person re-identification method, to separately obtain identification result data shown in Table 1 to Table 3.

TABLE 1

| Method | | | |
|---|---|---|---|
| (Identification | | | |
| method) | mAP | R-1 | R-5 |
| PNGAN | 72.6 | 89.4 | — |
| PABR | 76.0 | 90.2 | 96.1 |
| PCB + RPP | 81.6 | 93.8 | 97.5 |
| SGGNN | 82.8 | 92.3 | 96.1 |
| Mancs | 82.3 | 93.1 | — |
| MGN | 86.9 | 95.7 | — |
| FDGAN | 77.7 | 90.5 | — |
| DaRe | 76.0 | 89.0 | — |
| PSE | 69.0 | 87.7 | 94.5 |
| G2G | 82.5 | 92.7 | 96.9 |
| DeepCRF | 81.6 | 93.5 | 97.7 |
| SPReID | 81.3 | 92.5 | 97.2 |
| KPM | 75.3 | 90.1 | 96.7 |
| AANet | 83.4 | 93.9 | — |
| CAMA | 84.5 | 94.7 | 98.1 |
| IANet | 83.1 | 94.4 | — |
| DGNet | 86.0 | 94.8 | — |
| CASN | 82.8 | 94.4 | — |
| MMGA | 87.2 | 95.0 | — |
| OSNet | 84.9 | 94.8 | — |
| Auto-ReID | 85.1 | 94.5 | — |
| BDB + Cut | 86.7 | 95.3 | — |
| MHN-6 | 85.0 | 95.1 | 98.1 |
| P²-Net | 85.6 | 95.2 | 98.2 |
| Present | 89.0 | 95.5 | 98.3 |
| invention | | | |

TABLE 2

| Method | | | | |
|---|---|---|---|---|
| (Identification | | | | |
| method) | mAP | R-1 | R-5 | R-10 |
| G2G | 66.4 | 80.7 | 88.5 | 90.8 |
| DeepCRF | 69.5 | 84.9 | 92.3 | — |
| SPReID | 71.0 | 84.4 | 91.9 | 93.7 |
| PABR | 64.2 | 82.1 | 90.2 | 92.7 |
| PCB + RPP | 69.2 | 83.3 | 90.5 | 95.0 |
| SGGNN | 68.2 | 81.1 | 88.4 | 91.2 |
| Mancs | 71.8 | 84.9 | — | — |
| MGN | 78.4 | 88.7 | — | — |
| AANet | 74.3 | 87.7 | — | |
| CAMA | 72.9 | 85.8 | | |
| IANet | 73.4 | 87.1 | — | — |
| DGNet | 74.8 | 86.6 | — | — |
| CASN | 73.7 | 87.7 | — | — |
| OSNet | 74.8 | 86.6 | — | — |
| Auto-ReID | 75.1 | 88.5 | — | — |
| BDB + Cut | 76.0 | 89.0 | — | — |
| P²-Net | 73.1 | 86.5 | 93.1 | 95.0 |
| MHN-6 | 77.2 | 89.1 | 94.6 | 96.5 |
| Ours | 79.2 | 89.4 | 94.7 | 96.0 |

TABLE 3

| Method | | |
|---|---|---|
| (Identification | | |
| method) | R-1 | mAP |
| MGN | 66.8 | 66.0 |
| PCB + RPP | 63.7 | 57.5 |
| Mancs | 65.5 | 60.5 |
| DaRe | 63.3 | 59.0 |
| CAMA | 66.6 | 64.2 |
| CASN | 71.5 | 64.4 |
| OSNet | 72.3 | 67.8 |
| Auto-ReID | 73.3 | 69.3 |
| BDB + Cut | 76.4 | 73.5 |
| MHN-6 | 71.7 | 65.4 |
| P²-Net | 74.9 | 68.9 |
| Present | 78.8 | 75.3 |
| invention | | |

Market-1501 data set: It contains 32643 images with 1501 pedestrians captured by at least two cameras and at most six cameras from a supermarket. A training set and a test set respectively include 12936 images with 751 IDs and 19732 images with 750 IDs.

DukeMTMC-reID data set: It includes 36411 annotated boxes, among which 1812 persons are captured by 8 cameras. Among the 1812 persons, 1404 persons appear in more than two camera views, and the remaining persons are regarded as disturber identifiers. A training set of the data set includes 16522 images of 702 persons, and a test set includes 17661 gallery images and 2228 query images.

CUHK 03 data set: The data set includes 14097 images of a total of 1467 persons. The data set provides two border detection settings. One is manually annotated, and the other is automatically annotated by a detector. Experiments are conducted in both environments. The data set is divided into a training set of 767 persons and a test set of 700 persons.

In this embodiment, evaluation metrics, cumulative match characteristics (CMC), and mean average precision (mAP) are used as evaluation indicators to evaluate the identification performance of each method.

Evaluation of the Market-1501 data set: As can be seen from Table 1, the method proposed by the present invention is superior to other identification methods. Compared with the ManCs method which also uses attention and deep supervision operations, the accuracy of mAP and accuracy of R-1 in the present invention are respectively increased by 6.7% and 2.4%. In a single query mode, it is implemented that the accuracy of the mean average precision is 89.0%, the accuracy of the rank-1 is 95.5%, and accuracy of a rank-5 is 98.3%. In this way, the effectiveness of the method in the present invention is verified.

Evaluation of the DukeMTMCreID data set: As shown in Table 2, the mAP/rank-1 of the identification result of the method proposed by the present invention reaches 79.2%/89.4%, which respectively exceeds an MHN6 method by 2% and 0.3%.

Evaluation of the CUHK 03 data set: 767 persons are used for training and the remaining 700 persons are used for testing. From the data in Table 3, it can be seen that in the single query mode, the method proposed by the present invention is also superior to all other relatively advanced methods, showing calculation efficiency of the method in the present invention. Compared with a Mancs algorithm, the accuracy of the basic models mAP and R-1 in the present invention is increased by at least 13%.

What is claimed:

1. A person re-identification method combining reverse attention and multi-scale deep supervision, comprising the following steps:
S1. constructing a person re-identification training network comprising a feature extraction module and an identification output module, wherein a basic network of the feature extraction module uses a convolutional neural network ResNet50, and comprises a global branch, a reverse attention branch, and a multi-scale deep supervision branch;
S2. obtaining a training data set and a test data set;
S3. training the person re-identification training network by using the training data set, to obtain a person re-identification learning network; and shielding a reverse attention branch and a multi-scale deep supervision branch of a feature extraction module in the person re-identification learning network, to obtain a person re-identification test network;
S4. testing the person re-identification test network by using the test data set, and after the test succeeds, performing step S5; otherwise, returning to step S3;
S5. obtaining an actual data set and an actual query image;
S6. inputting the actual data set into the person re-identification learning network, to learn an image feature of the actual data set; then shielding the reverse attention branch and the multi-scale deep supervision branch of the feature extraction module in the person re-identification learning network, to obtain a person re-identification application network; and
S7. inputting the actual query image into the person re-identification application network, to obtain an identification result corresponding to the actual query image.

2. The person re-identification method combining reverse attention and multi-scale deep supervision according to claim 1, wherein the global branch in step S1 is used to extract global information of an image, comprising an attention module unit, an average pooling layer, and batch normalization that are sequentially connected, the attention module unit is divided into a first stage, a second stage, a third stage, and a fourth stage that are used for extracting a feature map, the attention module unit and the average pooling layer are combined to form a first global branch, and the attention module unit, the average pooling layer, and the batch normalization are combined to form a second global branch;
the reverse attention branch is used to extract, from feature maps extracted from the first stage to the fourth stage, feature information ignored by the attention module unit; and
the multi-scale deep supervision branch is used to extract feature information in horizontal and vertical directions from the feature maps extracted from the second stage and the third stage.

3. The person re-identification method combining reverse attention and multi-scale deep supervision according to claim 2, wherein the first global branch uses a ranked triplet loss function, and the second global branch uses an identity loss function; and
both the reverse attention branch and the multi-scale deep supervision branch use an identity loss function.

4. The person re-identification method combining reverse attention and multi-scale deep supervision according to claim 2, wherein the reverse attention branch comprises a reverse attention module unit and an average pooling layer that are sequentially connected, and input of the reverse attention module unit is separately output from the first stage to the fourth stage.

5. The person re-identification method combining reverse attention and multi-scale deep supervision according to claim 4, wherein the attention module unit comprises a channel attention module and a spatial attention module, and the channel attention module comprises one average pooling layer and two linear layers, to generate weight values corresponding to different channels; and
the spatial attention module comprises two dimension reduction layers and two convolutional layers, to enhance the significance of a feature at different spatial positions.

6. The person re-identification method combining reverse attention and multi-scale deep supervision according to claim 5, wherein specific calculation formulas of the attention module unit are as follows:
ATT=σ(ATT_{C}×ATT_{S});
ATT_{C}=BN(linear1(linear2(M_{C})));
ATT_{S}=BN(Reduction2(Conv2(Conv1(M_{C}))));
M_{C}=Avgpool(M);
Mϵ [symbol] ^{C*W*H},M_{C}ϵ [symbol] ^{C*1*1},
wherein ATT is an attention module, ATT_{C} indicates channel attention that is output, ATT_{S} indicates spatial attention that is output, linear1 is a first linear layer, linear2 is a second linear layer, BN the batch normalization, Conv2 and Conv1 respectively indicate two convolutional layers, Reduction2 indicates a second dimension reduction layer, AvgPool indicates an average pooling operation, M is a feature map, M_{C} is a feature map on which average pooling is performed, [symbol] ^{C*W*H} is a dimension of a feature map that is input, and [symbol] ^{C*1*1} is a dimension of a feature map obtained after average pooling operation is performed.

7. The person re-identification method combining reverse attention and multi-scale deep supervision according to claim 6, wherein a specific calculation formula of the reverse attention module unit is as follows:
ATT_{R}=1−σ(ATT_{C}×ATT_{S}),
wherein ATT_{R} is a reverse attention module.

8. The person re-identification method combining reverse attention and multi-scale deep supervision according to claim 1, wherein the multi-scale deep supervision branch comprises four convolution kernels on a one-dimensional scale, and sizes of the four convolution kernels on a one-dimensional scale are respectively 1×3, 3×1, 1×5, and 5×1.

9. The person re-identification method combining reverse attention and multi-scale deep supervision according to claim 3, wherein the identity loss function is specified as follows:
$${L}_{ID} = {\sum }_{i = 1}^{N} - {q}_{i} log ( {p}_{i} ) ;$$
$${q}_{i} = \{ \begin{matrix}1 - \frac{( N - 1 ) ɛ}{N} & if i = y \\ \frac{ɛ}{N} & otherwise\end{matrix} ; \\ ɛ = 0.1 ,$$
wherein L_{ID} is an identity loss, pᵢ is a prediction approximation, qᵢ is a smooth identity weight, y is a true identity of a sample, i is an identity predicted by a network, N represents a quantity of training samples, and ε is a constant.
